(19) United States
(12) Patent Application Publication
(10) Pub. No.: US 2005/0285050 A1
(43) Pub. Date: Dec. 29, 2005

(54) Sun sensor, an article incorporating the sun sensor and methods of preparation and use

(76) Inventor: Ian A. Bruce, Laguna Niguel, CA (US)

Correspondence Address: LADAS & PARRY, 26 WEST 61ST STREET, NEW YORK, NY, 10023, US

(21) Appl. No.: 11/068,525

(22) Filed: Feb. 28, 2005

Related U.S. Application Data
(60) Provisional application No. 60/548,594, filed on Feb. 27, 2004.

(51) Int. Cl. G01J 5/48

(52) U.S. Cl. 250/474.1

(57) ABSTRACT

A container for sunscreen having (a) an alphanumeric indication of a sun protection factor and (b) a solar detector for displaying whether accumulated ultraviolet radiation striking the skin of a user of sunscreen with the indicated sun protection factor has exceeded a threshold level. The solar detector has a sensor layer with a photochromic material that reacts to ultraviolet radiation by changing from a clear state to a colored one, and an ultraviolet absorbing or blocking material covering at least one portion of the sensor layer. The ultraviolet absorbing material covering the at least one portion being present in an amount or concentration such that, upon exposure of the solar detector means to the ultraviolet radiation striking the skin of the user of the sunscreen over the same period of time, blocks sufficient ultraviolet radiation from striking the photochromic material so as to prevent the photochromic material from changing color until the threshold level has been reached at which time the photochromic material changes from the clear state to the colored one.

### FIELD OF INVENTION

This invention relates to ultraviolet radiation sensors, and particularly to sensors that may be used to indicate the level of exposure of a sunscreen user to ultraviolet radiation and that takes account of the sun protection factor (SPF) in the sunscreen worn by the user.

### BACKGROUND OF INVENTION

Exposure to ultra violet radiation can cause a wide range of deleterious effects in human skin, including dehydration, burning, premature aging, and discoloration. In addition, it has been widely accepted and documented that excessive exposure to ultraviolet radiation can be carcinogenic in humans. Exposure to ultraviolet radiation is of a particular concern for individuals that spend a significant amount of time outside and exposed to the sun, and those having fair complexions and who are less tolerant to the sun's ultraviolet rays. In addition, damage to the earth's ozone layer and its ability to filter out ultraviolet radiation has further raised the concern over the harmful effects that exposure to ultraviolet radiation may have.

While sunscreen preparations are, to varying degrees, reasonably effective in filtering out harmful radiation and limiting the skin's exposure to the sun, they are limited with respect to their duration of usefulness. Commercially available sunscreen preparations are rated on what is commonly referred to as a sunscreen protection factor (SPF) scale. Generally the higher the SPF factor the greater the sunscreen protection that is provided. However, often individuals are unaware of the intensity of the sun's rays during a particular time of day, or with changing weather conditions, and do not realize that sunscreen having a certain SPF factor may not protect them adequately throughout the day. Moreover, the differences in natural characteristics of the skin of different individuals means that the effectiveness of sunscreens may vary dramatically for the different individuals.

For the above reasons a variety of devices have been developed in order to detect exposure to solar radiation. For example, U.S. Pat. No. 5,986,273 to Tripp et al (which is hereby incorporated herein by reference) describes an ultraviolet radiation sensor that visually indicates when it has been exposed to ultraviolet radiation. The sensor comprises photochromic ink that reversibly alters color upon exposure to sources of ultraviolet light. In general, photochromic inks function through molecular excitation as a result of exposure to ultraviolet light. That is, when exposed to ultraviolet light, molecular excitation of the ink causes a change in its color. Typically such inks can be activated by ultraviolet light having a wavelength of from 300 to 360 nanometers over a duration of 20 to 60 seconds. When the stimulus or source of ultraviolet light is removed so is the source of molecular excitation for the photochromic ink allowing the ink to return to a state of rest and to its original color or colorless format.

The sensor described in the '273 patent is intended to be worn by a user who must apply a topical sunscreen preparation on the surface of the sensor before every use at least partially to shield the ink from ultraviolet light. Depending upon the nature of the topical sunscreen preparation and its related sunscreen protection factor, varying amounts of ultraviolet light are filtered by the sunscreen and are prevented from triggering an immediate reaction with the photochromic ink. The device provides no means for warning the user in advance of this triggering event or for allowing the user to gauge the amount of accumulated ultraviolet radiation to which he or she has been exposed prior to such event.

U.S. Pat. No. 6,734,440 to Questel et al (which is hereby incorporated herein by reference) describes a device which can be used to indicate the amount of exposure to sunlight. The device is a multilayer sunlight dosage indicator comprising: (a) an indicator layer comprising a sunlight-sensitive ink, wherein the ink undergoes a color change upon exposure to a known amount of sunlight; and (b) an overlayer comprising an amount of at least one UV absorber. The patent also describes a method for indicating the amount of exposure to sunlight when the sunlight-sensitive ink undergoes a color change, and for adjusting the sensitivity of the indicator by adding UV absorbing materials to the overlayer. Again, however, the device does not alert the user in advance of the triggering event. Moreover, the patent makes no provision for correlation of the amount of UV absorber in the overlayer with the sun protection factor in the sunscreen of a sunscreen user.

There is, accordingly, a need for an article to which a user of sunscreen can refer over a period of time to ascertain the amount of accumulated ultraviolet radiation to which he or she has been exposed. Such device would desirably take account of the sun protection factor of the sunscreen being used and would preferably also take account of the user's skin characteristics. Such a device would allow an individual better to plan his or her outdoor activities as well as to decide when exposure to sunlight should be terminated.

### SUMMARY OF INVENTION

In accordance with a first embodiment of the invention, there is provided a container for sunscreen comprising (a) an alphanumeric indication of a sun protection factor and (b) solar detector means for displaying whether accumulated ultraviolet radiation striking the skin of a user of sunscreen with the indicated sun protection factor has exceeded a threshold level. The solar detector means comprises a sensor layer comprising a photochromic material that reacts to ultraviolet radiation by changing from a clear state to a colored one, and an ultraviolet absorbing or blocking material covering at least one portion of the sensor layer. The ultraviolet absorbing material covering the at least one portion is present in an amount or concentration that, upon exposure of the solar detector means to the ultraviolet radiation striking the skin of the user of the sunscreen over the same period of time, blocks sufficient ultraviolet radiation from striking the photochromic material so as to prevent the photochromic material from changing color until the threshold level has been reached.

In a preferred aspect of this embodiment, the ultraviolet absorbing material covers a plurality of portions of the sensor layer with an amount or concentration of the ultraviolet absorbing material covering the at least one portion of the sensor layer being greater than an amount or concentration of the ultraviolet absorbing material covering a second portion of the sensor layer such that, upon exposure of the solar detector means to ultraviolet radiation, the photochromic material in the second portion of the sensor layer changes color before the photochromic material in the at least one portion of the sensor layer. In a most preferred aspect of this embodiment, the ultraviolet material is present in a masking layer overlaying the sensor layer and the amount or concentration of the ultraviolet absorbing material in a portion of the masking layer covering the second portion of the sensor layer increases gradually from a first part of the masking layer to a second part of the masking layer whereby to provide for a change in color from one end of the second portion of the sensor layer to another upon exposure of the sun sensor to ultraviolet radiation over time. The gradual increase in the amount or concentration of the ultraviolet absorbing material in the masking layer can be achieved, for example, by a uniform increase in the width of the masking layer.

The ultraviolet absorbing material present in the masking layer may cover at least the first portion, the second portion and a third portion of the sensor layer with the amount or concentration of the ultraviolet absorbing material covering the third portion being greater than an amount or concentration of the ultraviolet absorbing material covering the second portion, the third portion being disposed on the sensor layer between the at least one and second portions. The container may include a caution or warning symbol next to the first and/or third portions to indicate that, when these portions change color, exposure to ultraviolet radiation may be reaching or at a threshold level.

In another embodiment of the invention, there is provided a solar detector comprising (a) a sensor article comprising at least one photochromic ink that reacts to ultraviolet radiation by changing from a clear state to a colored one, (b) at least a first masking article comprising at least one ultraviolet absorbing or blocking material that is present in the masking article in a concentration or amount that increases from a first of a plurality of portions of the masking article to a subsequent of the plurality of portions of the masking article whereby the first portion blocks less ultraviolet light than a subsequent portion, (c) connecting means for connecting the sensor article and the first masking article that allows for displacement of the first masking article with respect to the sensor article so that a different of the plurality of portions of the first masking article can be displaced to cover a different region of the sensor article in each of a plurality of different first masking article portion-sensor region combinations, and (d) alphanumeric means for indicating a correlation between each of the plurality of combinations and a sunscreen sun protection factor or a skin characteristic of a sunscreen user.

In a preferred aspect of this embodiment, the solar detector further comprises a second masking article comprising at least one ultraviolet absorbing or blocking material that is present in the second masking article in a concentration or amount that increases from a first of a plurality of portions of the second masking article to a subsequent of the plurality of portions of the second masking article whereby the first portion of the second masking article blocks less ultraviolet light than a subsequent portion of the second masking article. The connecting means connect the second masking article with the sensor article and the first masking article while permitting each of the first and second masking articles to be displaced with respect to one another and with respect to the sensor article so that each of the plurality of portions of the second masking article can be displaced to cover a different of the plurality of first masking article portion-sensor region combinations. The alphanumeric means can indicate a correlation between sun protection factor and skin characteristic for each of a plurality of possible combinations of the second masking article with the first masking article portion-sensor region combination.

In a further aspect of this embodiment, the solar detector may comprise a layer of polyethylene napthalate. Each of the sensor article, first masking article and second masking article may be in the form of a disk with the disks of at least the first masking layer and the second masking layer being rotatable. The solar detector may further comprise means for attaching the solar detector to a clothing item or person of a user.

Other aspects of the present invention in each of its emobidments, as well as the advantages thereof over existing prior art forms, will become apparent from the following brief description considered and interpreted in view of the accompanying drawing, and are accomplished by the improvements hereinafter described and claimed.

### BRIEF DESCRIPTION OF THE DRAWING

For a complete understanding of the objects, techniques and structure of the invention, reference should be made to the following detailed description and accompanying drawing wherein:

FIG. 1A is an exploded, perspective view of a sun sensor of the invention in a first embodiment affixed to a container surface shown in section;

FIG. 1B is an exploded, perspective view of a sun sensor of the invention in a second embodiment affixed to a container surface shown in section;

FIG. 2A is a front plan view of the sun sensor and container of FIG. 1A;

FIG. 2B is a front plan view of the sun sensor and container of FIG. 1B;

FIG. 3 is top plan view of a sun sensor of the invention in a second embodiment;

FIG. 4A is an exploded, perspective view of the sun sensor of FIG. 3 in a first embodiment; and

FIG. 4B is an exploded, perspective view of the sun sensor of FIG. 3 in one variant;

FIG. 5 is a perspective view of the sun sensor of FIG. 3 in yet another variant;

FIG. 6 shows the transmittance spectrum of a preferred UV absorber, ADA 1160, for use with the invention.

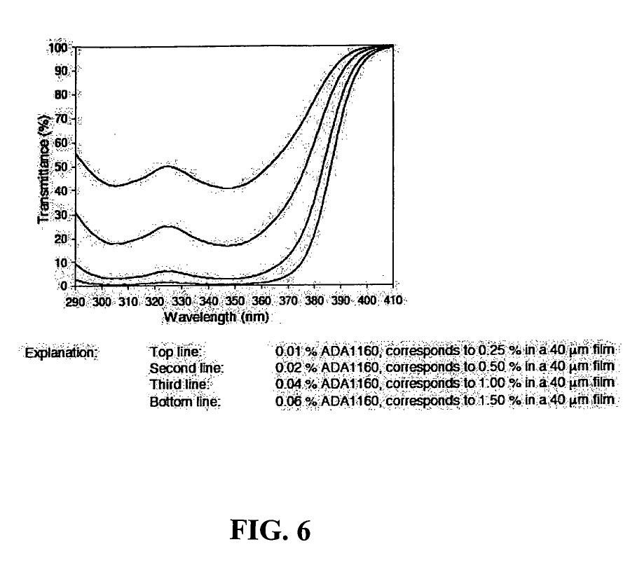

### DETAILED DESCRIPTION

In the first embodiment, the invention comprises a “printable” ultraviolet (UV) meter for a sun-care product, e.g., sun-tan lotion, packaging. It can be applied either during the normal label printing process with no equipment modifications, or applied afterwards as an adhesive patch. It functions by using a UV-responsive material, e.g., a photochromic dye that alters its color, preferably reversibly, upon exposure to UV light.

Photochromic dyes reversibly alter their color upon exposure to ultraviolet sources. These chameleon-like dyes respond to natural solar irradiation as well as artificial sources such as 365-nanometer “black light.” When sunlight or UV radiation is applied, the dye becomes excited and the molecular structure is changed allowing a color to appear. When the stimulus (sunlight/UV) is removed, the dye will return to a state of rest, which is its colorless form.

In typical applications, full color changes appear with exposure to UV light from milliseconds using a flashgun 20 to 60 seconds in the sunlight. When the UV source is removed, bleaching usually takes place from seconds to a few minutes but can take much longer depending on the specific photochromic, matrix, temperature, and light source.

Suitable photochromic dyes and other sunlight sensitive inks for use in this invention include those described for example, in U.S. Pat. Nos. 5,986,273; 6,734,440 and 5,581,090, which are incorporated herein by reference. A preferred sun sensitive dye for use in the invention is available from PPG and is sold under the trademark “PHOTOSOL”.

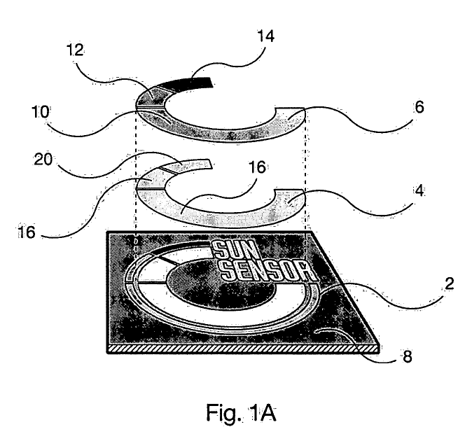

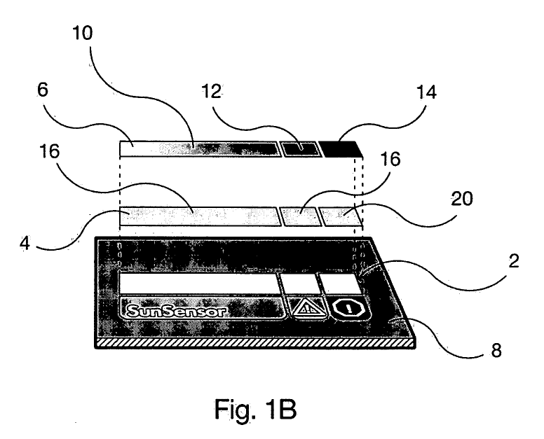

In the first embodiment of the invention, a highly efficient UV resistive masking layer is applied over the photochromic material. This is shown with reference to FIGS. 1A and 1B wherein UV resistive masking layer 6 overlays photochromic ink layer 4 which in turn overlays a substrate 2 which is affixed to a container surface 8. The masking layer 6 has separate portions 10, 12 and 14, each of which may have a different concentration of a UV resist or absorber than the others. As shown in FIGS. 1A and 1B, portions 10, 12 and 14 of the masking layer are made to overlay respective regions 16, 18 and 20 of the photochromic ink layer 4. As will be appreciated by those of skill in the art, regions of the photochromic ink layer 4 that are covered by portions of the masking layer 6 that have a greater concentration of the UV resist will take longer to change from a rest (colorless) condition to an active (colored) state.

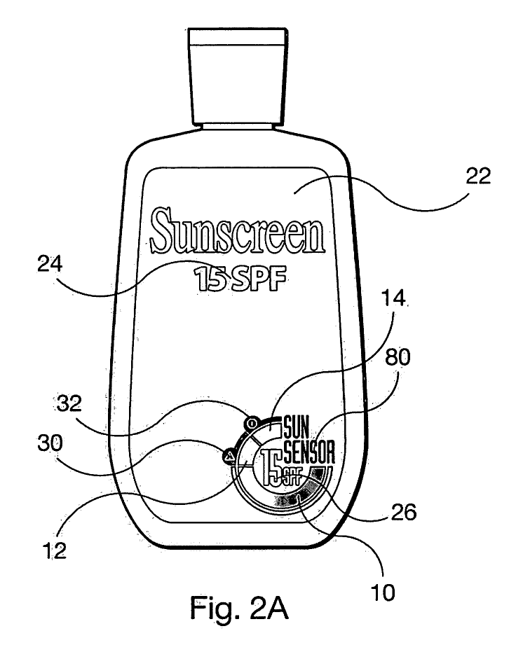

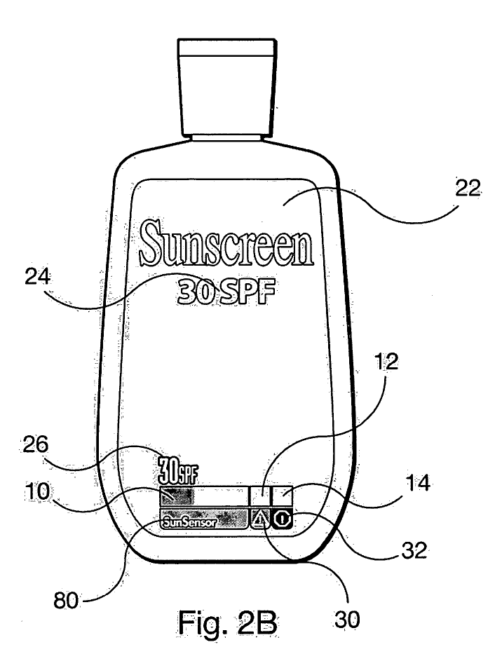

In a preferred embodiment of the invention, portion 10 of the masking layer 6 is a gradient analog portion wherein the UV absorber is present in progressively greater concentration. Masking layer 6 also has two binary patches 12 and 14, each having a uniform density of UV resist. Each of the binary patches 12 and 14 has a higher concentration of UV resist than in the gradient portion 10 with the binary patch 14 having a higher concentration than the binary patch 12. The resist gradient and binary patches may each be specifically calibrated to a marked SPF factor of a product to which the sun sensor of the invention is applied. So, for example, with reference to FIGS. 2A and 2B, a sun sensor 80 for a container 22 for sunscreen with an SPF of 15, as indicated alphanumerically at 24 and 26, would change color much faster than a sun sensor for a container for sunscreen with an SPF of 30, owing for example to a lower density UV resist gradient. The binary patches 12 and 14 would be indicators of caution and danger respectively and the container 22 would bear indicators 30 and 32 to that effect. An additional calibrating layer of a UV resistance film (not shown) may be included either above the photochromic layer or above one of the other layers, if necessary or desirable for proper calibration of the sun sensor.

As may be appreciated, the respective concentrations of ultraviolet absorber in the masking layer 6 function selectively to adjust the response time of the underlying regions 16, 18, 20 of photochromic layer 4. So, for example, a colorless lacquer can absorb UV radiation, thereby decreasing the amount of radiation reaching the photochromic ink in the indicator layer. The more UV radiation absorbed by a portion of the masking layer, the more sunlight necessary to cause the ink to change color. Therefore, the more UV absorber a portion of the masking layer contains, the greater the exposure to sunlight required to produce a color change in the sun sensor.

For purposes of this specification, the term UV absorber refers to a substance that absorbs radiation having a wavelength of from about 230 nanometers (nm) to about 365 nm. For example, ethyl cellulose is a UV absorber. A masking layer 2 mils thick, comprising ethylcellulose, transmits only about 40% of light having a wavelength of 260 nm.

The amount of UV absorber present in a portion of the masking layer affects the response time of a region of the sensor covered by that portion of the masking layer. The more UV absorber present in a portion of the masking layer, the more exposure to sunlight necessary to reach the sensor layer and cause the photochromic ink to change color. A known amount of UV absorber in a portion of the masking layer corresponds to a known amount of UV radiation absorbed. Because the ink changes color only after exposure to a known amount of sunlight, the amount of exposure required for a color change in a specific region of the sensor layer can be manipulated by selecting the amount of UV absorber in a corresponding portion of the masking layer.

For example, where a first portion of the masking layer comprises a first amount of the UV absorber component, the photochromic ink in a corresponding first region of the sensor layer could be made to change color after an exposure of about 25 mW/m². In contrast, where a second portion of the masking layer comprises a second, higher amount of the UV absorber component, the photochromic ink in a corresponding second region of the sensor layer could be made to change color after an exposure of about 70 mW/m². The following table shows the possible threshold levels of UV radiation that could indicated by the sun sensor of the invention.

| milliWatts/square meter | Index value | Exposure Category |
|---|---|---|
| <25 | About 1 | Low |
| <70 | 3 | Mmoderate |
| 75-150 | 3-6 | High |
| 151-580 | 6-10 | Very High |
| >580 | 10+ | Extreme |

The total amount of UV radiation absorbed by the human skin during the day, is expressed in kJ/m2. The maximum safe level is between 2 to 4 kJ/m².

Adjustments in the amount of radiation absorbed in select portions of the masking layer can be made by adjusting the thickness of those portions of the masking layer or by adding additional UV absorber components to those portions of the masking layer. Examples of components that absorb UV radiation include light stabilizers such as benzophenones, benzotriazoles, and triazines. A preferred UV absorber is 2,2′-dihydroxy-4-methoxybenzophenone, available as Cyasorb UV-24, from Cytec Industries. The mixture used to form the masking layer may further comprise solvents, binders, surfactants, viscosity control agents, polymers, and the like.

A more preferred UV absorber for use in the first embodiment of the invention, as shown in FIGS. 1A and B, is a UV absorber comprising a hydroxy phenyl-benzotriazole, such as the one available commercially from H.W. Sands Corp. of Jupiter, Fla. as ADA 1160. ADA1160 is a UV absorber of the hydroxyphenylbenzotriazole class for coatings. Because of its extended UV absorption, ADA 1160 provides efficient protection to coated light sensitive substrates. It has the following physical properties:

Appearance:
slightly yellow powder

Melting point: 80-88° C.

Specific density at 20° C.: 1.17 g/cm³

Recommended Concentrations
1-3% of ADA 1160

Solubility at 20° C. (g/100 g solution):

| | |
|---|---|
| butylcarbitol | 3.5 |
| butanol | 2.5 |
| butylacetate | 15 |
| ethylglycol | 4 |
| 1-methoxypropylacetate-2 | 10 |
| methylethylketone | 14 |
| xylene | 34 |
| water | <0.01 |

A preferred concentration of this UV absorber is 1-3% per volume of print media.

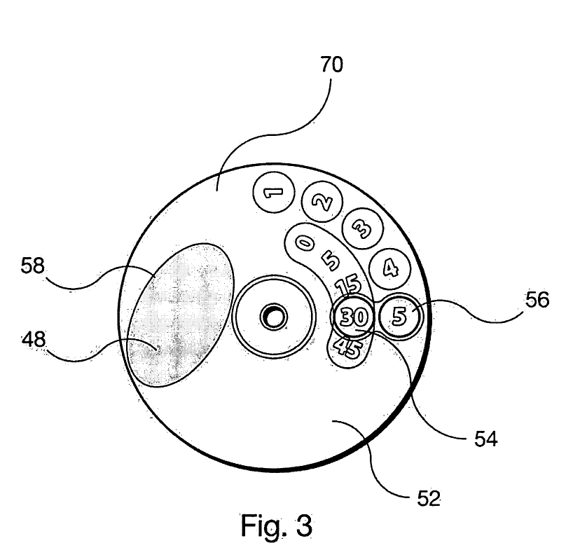

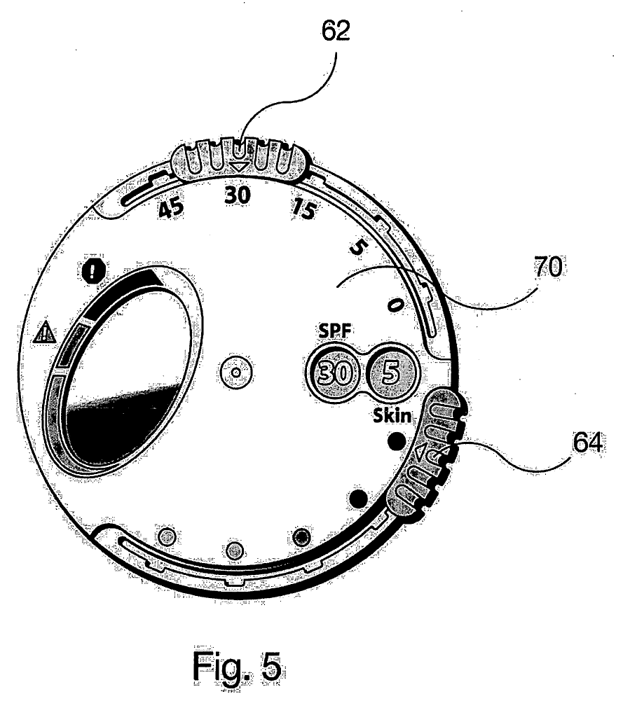

In a second embodiment, the invention comprises a portable version of the sun sensor of the first embodiment that may be used independently of a sun care product. This embodiment will be described with reference to FIGS. 3-5, wherein sun gauge 70 comprises UV resist discs 40 and 44 that are circumferentially graduated in the same clockwise direction from less to more resistance on portions of the discs that may be under the left-hand window 58 of cover 52 and over a photochromic layer 48 of disc 46 with the range of movements permitted by their respective glides 60 and 62 (FIG. 5). These movements correspondingly position the skin-type number indicators 64 and SPF number indicator 66 arcuately on the discs in correspondence with the resist graduation of the discs for appearing in their respective windows 54 and 56 of cover 52. A non-rotating layer 44 of polyethylene napthalate (PEN) may optionally be sandwiched, for example, between the UV resist disks 40 and 42 or between UV resist disk 44 and disc 46. A fixed level of UV resistance may be added with another disc or patch between the photochromic layer 48 and the UV resist discs. Although not presently preferred, the photochromic layer could also be repeated for rotation under the left-hand window for instant re-setting.

In use, a user dials in his or her skin type and a sun protection factor of a sunscreen, if any, by rotating the two independently rotatable UV masking disks 40 and 42 above the photochromic dye patch 48. The skin type is dialed in by sliding the peripheral glide 62 until a number and/or color indicating a desired skin type appears in adjacent window 72. The sun protection factor is dialed in by sliding glide 60 until a number indicating the sun protection factor of the sunscreen being used appears in window 74. The skin type settings or SPF that a user selects in one of the embodiments of this invention may be made with reference to indices that are available to the public. So, for example, all embodiments of the present invention may be used with the following indices:

UV Index Data:

The UV Index (short for “Ultraviolet Ray Index”) is a next-day forecast of the amount of skin-damaging UV radiation that is expected to reach Earth's surface when the sun is highest in the sky (solar noon). It was created to help people make informed decisions about the amount of time that they spend in the sun.

| Index Scale | UV Exposure Level |
|---|---|
| 0-2 | Very low |
| 3-4 | Low |
| 5-6 | Medium |
| 7-9 | High |
| 10+ | Very high |

The UV Index is issued daily to advise on the strength of the sun's UV rays in a region. One checks the index to know how much sun protection one needs each day.

The UV Index is based on monitoring the sun's position, cloud movements, altitude, ozone data, and other factors. Each year the National Weather Service performs a validation of the UV Index forecasts by incorporating the help from several government agencies and private companies, hospitals, and colleges, that provide observations of surface UV radiation. From these observations, statistical corrections are made to ensure accuracy of the index.

While it is well known that the Earth's ozone decreases the amount of UV rays one receives, the exact impact of ozone depletion is not yet fully understood. However, some local factors such as smog, or the type of reflective surface one is near, can also determine the amount of exposure one receives. For example, water, sand, snow, and concrete can all reflect ultraviolet rays, increasing exposure.

The following UV Index chart shows how quickly a person's skin will burn without sunscreen.

[image]

Skin Type Index

The 1-5 skin type index corresponds to the lower “Skin” of the invention. There is a “6”, but it is not a risk group.

| Skin Type | History of Sunburning or Tanning |
|---|---|
| 1 | Always burns easily, never tans |
| 2 | Burns easily, tans minimally |
| 3 | Burns moderately, tans gradually to light brown |
| 4 | Burns minimally, always tans well to moderately brown |
| 5 | Rarely burns, tans profusely to dark brown |

The photochromic layers used in this invention may be made by the incorporation of photochromic molecules into a polymer matrix by methods known in the art (see, for example, U.S. Pat. No. 6,437,346, which is incorporated herein by reference). The host polymer matrix may preferably be optically transparent in the visible spectrum to be able to see the color change of the photochromic molecules imbedded in the matrix.

Alternatively, the photochromic layer may be prepared by dissolving a photochromic dye in an organic solvent, preferably non-polar solvent, and mixing the obtained solution with an ink vehicle in a manner known to those of skill in the art (cf., U.S. Pat. Nos. 5,581,090 and 5,914,197). In this embodiment, the ink vehicle plays the role of the polymer host matrix. Ultraviolet stabilizers and anti-oxidants are preferably added to the mixture to increase lifetime of the photochromic compounds. The obtained photochromic ink mixture is then applied as a thin layer on a white sheet of plastic, coated paper or any other suitable substrate material by known printing techniques such as screen printing. The layer is then allowed to dry by solvent evaporation.

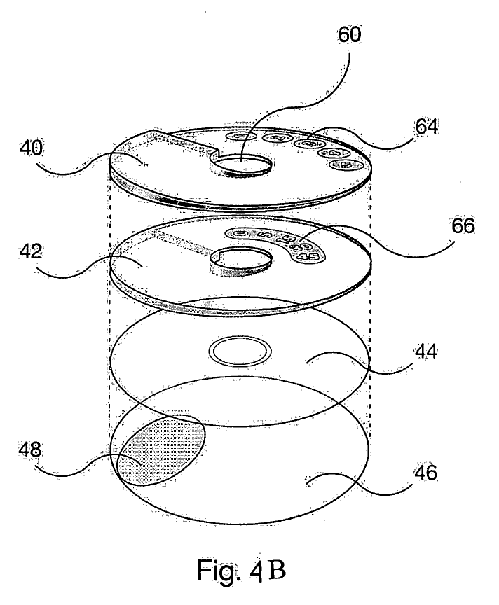

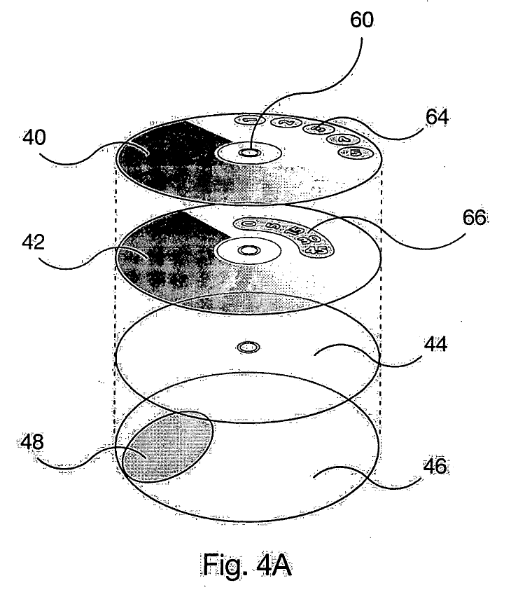

With respect to the second embodiment the invention, as shown in FIGS. 4A and 4B, the layers of UV material preferably comprise PEN. PEN is a homopolymer resin which blocks UV radiation at wavelengths substantially higher than many other common thermoplastic polymers. PEN is visibly transparent yet provides a highly effective UV-protective barrier that prohibits transmission of UV light up to 383 nm. In a preferred embodiment of the invention, as shown in FIG. 4B, the thickness of the respective PEN layers may gradually increase from one portion of the layer to another.

Suitable substrates include any material to which the indicator layer will adhere. White or light-colored materials do not mask the color change of the photochromic ink, and are therefore preferred. Suitable materials for use as a substrate include, but are not limited to, white lithographic paper, white polyvinyl chloride (PVC) film, or other paper, film, or foil having a white, opaque coating. In a preferred embodiment of the present invention, the photochromic ink mixture may be applied to the substrate by ejecting droplets of the ink mixture from an ink jet printer onto a surface of the substrate.

The material that changes color is present in the ink mixture in an amount sufficient to effect the required color change, preferably in an amount of 5-30 wt %. Other ingredients preferably included in the ink mixture include ultraviolet light stabilizers and anti-oxidants to prolong the life of the photochromic material.

In a preferred embodiment of the invention droplets of the ink mixture may be ejected from the recording head of an ink jet printer onto a substrate in amounts sufficient to create a photochromic layer. Then droplets of a UV absorber or resist may be ejected from the printer to cover the photochromic layer in the respective amounts desired.

1. A container for sunscreen comprising (a) an alphanumeric indication of a sun protection factor and (b) solar detector means for displaying whether accumulated ultraviolet radiation striking the skin of a user of sunscreen with the indicated sun protection factor has exceeded a threshold level, the solar detector means comprising a sensor layer comprising a photochromic material that reacts to ultraviolet radiation by changing from a clear state to a colored one, and an ultraviolet absorbing or blocking material covering at least one portion of the sensor layer, the ultraviolet absorbing material covering the at least one portion being present in an amount or concentration such that, upon exposure of the solar detector means to the ultraviolet radiation striking the skin of the user of the sunscreen over the same period of time, blocks sufficient ultraviolet radiation from striking the photochromic material so as to prevent the photochromic material from changing color until the threshold level has been reached at which time the photochromic material changes from the clear state to the colored one.

2. The container as claimed in claim 1, wherein the ultraviolet absorbing material covers a plurality of portions of the sensor layer with an amount or concentration of the ultraviolet absorbing material covering the at least one portion of the sensor layer being greater than an amount or concentration of the ultraviolet absorbing material covering a second portion of the sensor layer such that, upon exposure of the solar detector means to ultraviolet radiation, the photochromic material in the second portion of the sensor layer changes color before the photochromic material in the at least one portion of the sensor layer.

3. The container as claimed in claim 2, wherein the ultraviolet absorbing material is present in a masking layer at least partially covering the sensor layer, wherein the amount or concentration of the ultraviolet absorbing material in a portion of the masking layer covering the second portion of the sensor layer increases gradually from a first part of the masking layer to a second part of the masking layer whereby to provide for a progressive change in color from one end of the second portion of the sensor layer to another upon exposure of the container to ultraviolet radiation over time.

4. The container as claimed in claim 3, wherein the masking layer has a thickness that progressively increases from the first part to the second part.

5. The container as claimed in claim 3, wherein the masking layer covers at least the at least one portion, the second portion and a third portion of the sensor layer with the amount or concentration of the ultraviolet absorbing material covering the third portion being greater than an amount or concentration of the ultraviolet absorbing material covering the second portion, the third portion being disposed on the sensor layer between the at least one and second portions.

6. The container as claimed in claim 2, comprising sunscreen with the indicated sun protection factor.

7. The container as claimed in claim 2, wherein the photochromic material comprises at least one compound that changes color reversibly upon exposure to UV light.

8. The container as claimed in claim 7, wherein the ultraviolet absorbing material comprises a hydroxyphenyl benzotrizole UV absorber.

9. A solar detector comprising (a) a sensor layer comprising a photochromic material that reacts to ultraviolet radiation by changing from a clear state to a colored one, and (b) a masking layer comprising an ultraviolet absorbing or blocking material covering at least a portion of the sensor layer with an amount or concentration of the ultraviolet absorbing material covering a first portion of the sensor layer being greater than an amount or concentration of the ultraviolet absorbing material covering a second portion of the sensor layer such that, upon exposure of the solar detector to ultraviolet radiation over a period of time, the photochromic material in the second portion changes color before the photochromic material in the first portion, the amount or concentration of the ultraviolet absorbing material covering the first portion being sufficient to prevent the photochromic material in the first portion from changing color until the solar detector has been exposed to a threshold level of accumulated ultraviolet radiation in the range of 25 mW/m².

10. The solar detector as claimed in claim 9, wherein the amount or concentration of the ultraviolet absorbing material in a portion of the masking layer covering the second portion of the sensor layer increases gradually from a first part of the masking layer to a second part of the masking layer whereby to provide for a progressive change in color from one end of the second portion of the sensor layer to another upon exposure of the solar detector to ultraviolet radiation over a period of time.

11. A solar detector comprising (a) a sensor article comprising at least one photochromic material that reacts to ultraviolet radiation by changing from a clear state to a colored one, (b) at least a first masking article comprising at least one ultraviolet absorbing or blocking material that is present in the first masking article in a concentration or amount that increases from a first of a plurality of portions of the masking article to a subsequent of the plurality of portions of the masking article whereby the first portion is capable of blocking less ultraviolet light than a subsequent portion, (c) connecting means for connecting the sensor article and the first masking article that allows for displacement of the first masking article with respect to the sensor article so that a different of the plurality of portions of the first masking article can be displaced to cover a different region of the sensor article in each of a plurality of different first masking article portion-sensor region combinations, and (d) means for indicating a correlation between each of the plurality of combinations and a sunscreen sun protection factor or a skin characteristic of a sunscreen user.

12. The solar detector as claimed in claim 11, comprising a second masking article comprising at least one ultraviolet absorbing or blocking material that is present in the second masking article in a concentration or amount that increases from a first of a plurality of portions of the second masking article to a subsequent of the plurality of portions of the second masking article whereby the second portion of the second masking article is capable of blocking more ultraviolet light than a subsequent portion of the second masking article, said connecting means connecting the second masking article with the sensor article and the first masking article while permitting each of the first and second masking articles to be displaced with respect to one another and with respect to the sensor article so that each of the plurality of portions of the second masking article can be displaced to cover a different of the plurality of first masking article portion-sensor region combinations, said means indicating a correlation between sun protection factor and skin characteristic for each of a plurality of possible combinations of the second masking article with the first masking article portion-sensor region combination.

13. The solar detector as claimed in 12, further comprising an article of polyethylene napthalate connected by the connecting means to the sensor article and the first and second masking articles.

14. The solar detector as claimed in claim 12, wherein each of the sensor article, first masking article and second masking article is in the form of a disk and wherein the disks of at least the first masking article and the second masking article are rotatable.

15. The solar detector as claimed in claim 14, further comprising means for attaching the solar detector to a clothing item or person of a user.

16. A method for preparing a solar detector comprising: (a) providing a sensor layer comprising a photochromic material that reacts to ultraviolet radiation by changing from a clear state to a colored one; (b) determining a level of accumulated ultraviolet radiation striking the skin of a user of sunscreen with a known sun protection factor that results in the user's skin being exposed to a threshold dose of ultraviolet radiation; (c) covering at least a first portion of the sensor layer with at least one ultraviolet absorbing material in an amount or concentration that blocks sufficient ultraviolet radiation from striking the at least first portion so as to prevent the photochromic material in the first portion from changing color until the level has been reached and that allows the photochromic material to change color thereafter.

17. The method as claimed in claim 16, wherein the method comprises covering a second portion of said sensor layer with said at least one ultraviolet absorbing material in an amount or concentration that is less than the amount or concentration of the ultraviolet absorbing material covering the first portion of the sensor layer.

18. The method as claimed in claim 17, comprising forming the sensor layer by (a) providing a substrate, and (b) depositing a photochromic ink or dye onto the substrate by ejecting droplets of the ink or dye onto the substrate with an ink jet printer.

19. The method as claimed in claim 18, comprising covering the at least first portion of the sensor layer with the ultraviolet absorbing material by ejecting droplets of the utraviolet absorbing material onto the sensor layer with the ink jet printer.
